(19) United States
(12) Patent Application Publication
(10) Pub. No.: US 2002/0163524 A1
(43) Pub. Date: Nov. 7, 2002

(54) System and method for automatic adjustment of backlighting, contrast and color in a data processing system

(75) Inventor: Rabindranath Dutta, Austin, TX (US)

Correspondence Address: Kelly K. Kordzik, Suite 800, 100 Congress Avenue, Austin, TX, 78701, US

(73) Assignee: International Business Machines Corporation

(21) Appl. No.: 09/732,483

(22) Filed: Dec. 7, 2000

(51) Int. Cl. G09G 5/02

(52) U.S. Cl. 345/589

(57) ABSTRACT

Within a data processing device, such as a personal digital assistant, the backlight and contrast of a display can be automatically adjusted in response to lighting conditions monitored by a light meter connected to this system. As the device monitors a change in the light condition within which the device is being utilized, a process will modify whether the backlight will turn on or off and what value of contrast will be used. Likewise, a miniature video camera can also be attached to the device and its input used to adjust color values of images displayed on the device, including selected various color schemes to be used within various lighting conditions.

### TECHNICAL FIELD

The present invention relates in general to data processing systems, and in particular, to the display of information in data processing systems.

### BACKGROUND INFORMATION

Personal digital assistants (“PDAs”), PDA watches, laptop computers, and any other data processing device that makes use of passive display devices, such as those based on liquid crystal display (“LCD”) technology are notoriously difficult to read in certain lighting conditions. This is especially true with respect to portable devices with LCD screens, since their portability inherently means that the lighting conditions within which they will be utilized will greatly vary, from bright outdoor sunlight to dimly lit commuter trains.

The amount of backlight and contrast are the main factors affecting readability of text and other images on such display screens. Typically, such backlighting and contrast are manually adjustable using hardware buttons (e.g., contrast knob on the side of a PDA). Backlighting may also be adjusted on such PDAs using a Ronomatic stroke, but this typically only adjusts the backlighting to be either on or off. (A Ronomatic stroke is an action performed by dragging a stylus on a touch screen device.) Because such portable devices are often going through significant lighting condition changes, such as when being utilized on a fast moving train, it is inconvenient and bothersome to have to continually manually adjust the backlighting and the contrast to optimize the readability of the text and images on the display screen. As a result, there is a need in the art for an ability to automatically adjust the readability of the text and images on a data processing system device, particularly when environmental lighting conditions are changing.

### SUMMARY OF THE INVENTION

The present invention addresses the foregoing need by providing a light meter on a data processing device, which monitors the lighting conditions of the environment in which the device is being utilized. As these lighting conditions vary, a process within the device will read a register value associated with the lighting condition read from the light meter, and will consequently automatically adjust the contrast and/or backlight of the device. Such adjustments may be performed by reading in a lighting condition value from the light meter register into a table, which will then output corresponding backlight and contrast values, which are then sent to the circuitry for adjusting the backlight and contrast of the display screen.

In an alternative embodiment, such a table can be customized by the user so that desired contrast and backlight conditions are customized by the user for specified lighting conditions.

In yet another alternative embodiment of the present invention, a video camera would be connected to the data processing device to monitor the lighting conditions in which the device is utilized for adjusting the color settings of the display screen. This is performed in much the same manner as the automatic adjustment of the contrast and backlight described above, except that the color scheme of images displayed to the user are automatically adjusted depended upon the lighting in which the device is utilized. In an alternative embodiment, such color settings may also be customized by the user.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates a PDA figured in accordance with the present invention;

FIG. 2 illustrates hardware components of a PDA configured in accordance with the present invention;

FIG. 3 illustrates software components of a PDA configured in accordance with the present invention;

FIGS. 4 and 5 illustrate examples of contrast and backlight settings for monitored lighting conditions;

FIG. 6 illustrates a table used by an embodiment of the present invention to automatically determine the backlight and contrast associated with various lighting conditions;

FIG. 7 illustrates a flow diagram for customizing the table illustrated in FIG. 6;

FIG. 8 illustrates a flow diagram of a process in accordance with the present invention for setting the backlight and contrast values;

FIG. 9 illustrates a table for determining color settings as a function of lighting conditions;

FIG. 10 illustrates a flow diagram for customizing the table illustrated in FIG. 9;

FIG. 11 illustrates a flow diagram configured to adjust a color setting of a display device as a function of the lighting conditions within which it is operated; and

FIGS. 12 and 13 illustrate examples of processes for determining color settings within a data processing system.

### DETAILED DESCRIPTION

In the following description, numerous specific details are set forth such as specific system configurations, etc. to provide a thorough understanding of the present invention. However, it will be obvious to those skilled in the art that the present invention may be practiced without such specific details. In other instances, well-known circuits have been shown in block diagram form in order not to obscure the present invention in unnecessary detail. For the most part, details concerning timing considerations and the like have been omitted in as much as such details are not necessary to obtain a complete understanding of the present invention and are within the skills of persons of ordinary skill in the relevant art.

Refer now to the drawings wherein depicted elements are not necessarily shown to scale and wherein like or similar elements are designated by the same reference numeral through the several views.

The present invention will be described below with respect to a personal digital assistant (“PDA”), but is also applicable to any other data processing system device that utilizes a display whose color, brightness and/or contrast is adjustable. The present invention is applicable to not only portable devices, but also to desktop computers, since such computers could be configured to use the present invention.

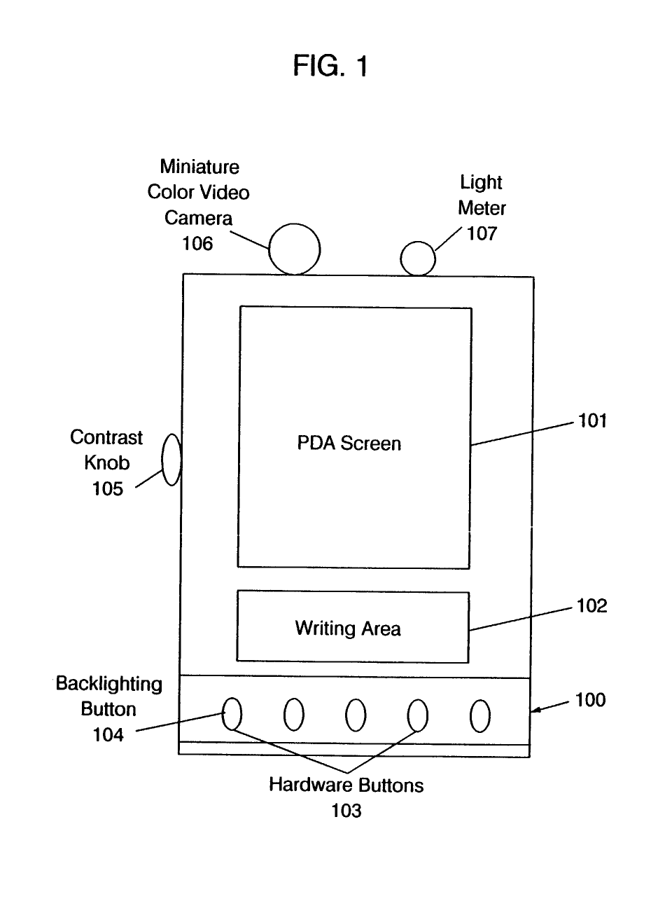

FIG. 1 illustrates a PDA 100 configured in accordance with the present invention, as will be described in more detail below. PDA 100 includes a display screen 101, a writing area 102, and hardware buttons 103, one of which can be a backlighting button 104 enabling the user to either turn on or off a backlight for the display screen 101. Additionally, a contrast knob 105 is available for the user to adjust the contrast of the display screen 101. PDA 100 also includes a light meter for monitoring the brightness of the lighting conditions of the environment within which the PDA 100 is being utilized. Furthermore, in an alternative embodiment, a miniature color video camera 106 may also be mounted on the PDA 100 for monitoring the lighting conditions within the environment within which the PDA 100 is being utilized.

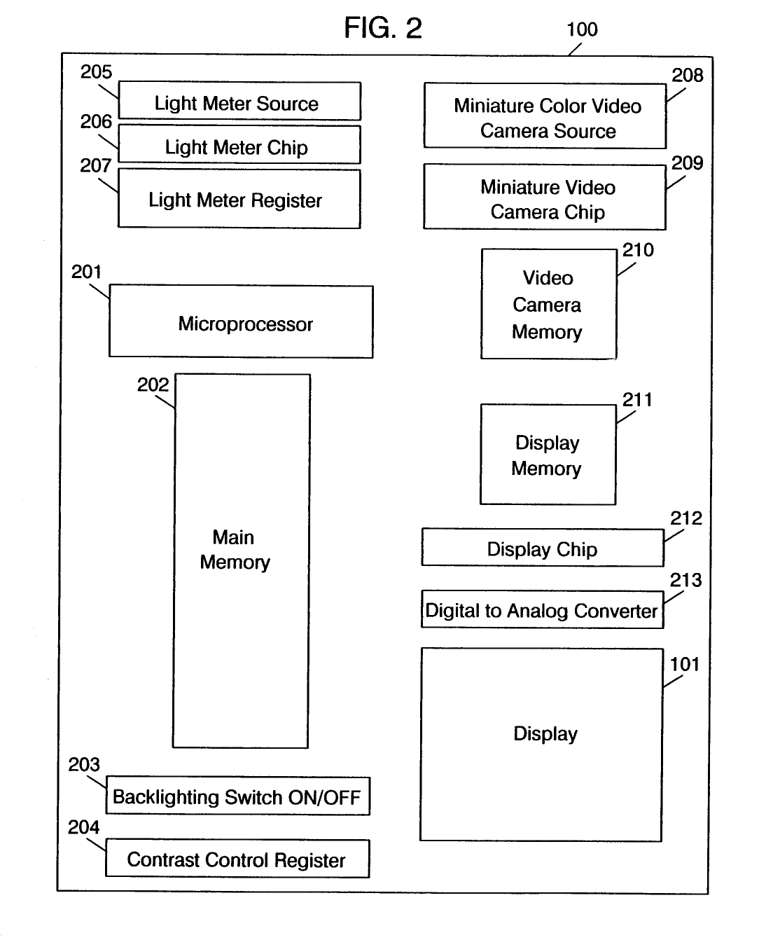

Referring to FIG. 2, there are illustrated hardware components utilized within PDA 100. As is expected, PDA 100 includes a microprocessor 201 and a main memory 102. Furthermore, as is typical within data processing systems, display 101 will be driven by images sent from a display memory 211, which are manipulated by a display integrated circuit (“chip”) 212, and then converted from digital to analog by converter 213 for display on display 101.

Light meter 107 (see FIG. 1) is connected to a light meter source 205 (containing hardware to convert light information into electronic signals), operated by a light meter chip 206. The light meter 107 will monitor the relative brightness of lighting within the environment of the PDA 100, and this value will then be digitized and stored within light meter register 207. As an example, light meter register 207 may be able to take on values from 0 through 9 representing relative brightness levels of dark to light. The light meter register 207 value will continually change as a function of the lighting conditions monitored by light meter 107. Naturally, light meter register 207 can be read by a process running within microprocessor 201.

Contrast control register 204 also represents a value of relative contrast. For example, minimum contrast might be represented by a zero value, while maximum contrast might be represented by a value of ten. Contrast knob 105 may be connected to register 204 to be able to adjust the contrast value within register 204 as a function of the manual manipulation of contrast knob 105 by the user. Alternatively, as described in further detail below, the value within register value 204 can be written to by a software process running within microprocessor 201. This contrast control register 204 value is then read by applications running within PDA 100, and possibly by display chip 212, to vary the contrast of the images displayed on display 101 in a manner that is well known in the art. For example, such software programs as Adobe Photoshop, made by Adobe Systems, Inc., can make use of user selected contrast control values to adjust the gray scale of the various pixels in display 101.

Backlighting switch 203 is also a register that stores a binary value, which will turn on or off the display 101 backlight (not shown). Backlight switch register 203 can be coupled to a hardware button such as button 104, enabling the user of the PDA 100 to manually turn on or off the backlight of display 101. Since backlighting switch register 203 is an addressable register, it can also be modified by a process running within microprocessor 201, as will be described below.

Alternatively, the present invention may also include a miniature video camera 106, which is connected to source 208 that is controlled by miniature video camera chip 209. Images received from camera 106 through source 208 are then stored within video camera memory 210. Video camera memory 210 can be delivered to display memory 211 so that images from the video camera 106 can be displayed on display 101.

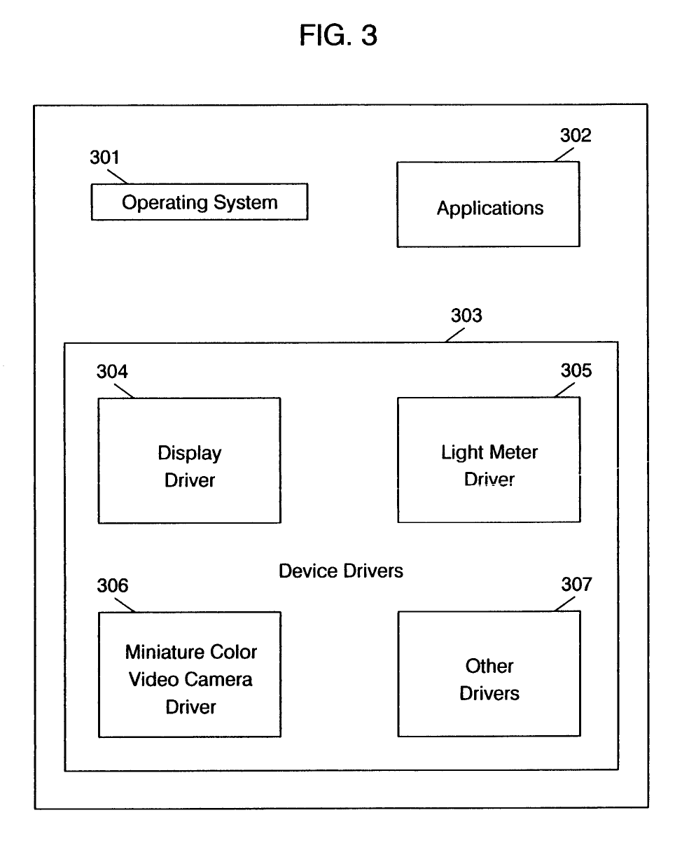

Referring to FIG. 3, there are illustrated software programs utilized within the system described with respect to FIG. 2 for operating the present invention. As expected, the hardware of PDA 100 will utilize an operating system 301 and will be capable of running various applications 302, such as web browser applications, spreadsheet applications, email applications, address applications, etc. Also included will be various device drivers 303, including a display driver 304 operating in conjunction with display chip 212, a light meter driver 305 operating in conjunction with light meter chip 206, a miniature color video camera driver 306 operating in conjunction with miniature video camera chip 209, and any other drivers 307 required within PDA 100.

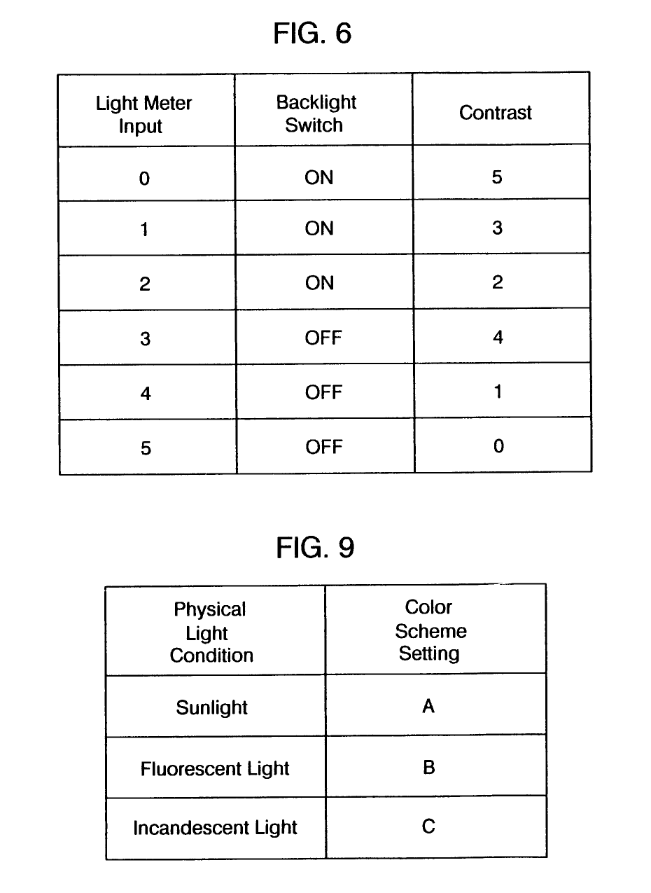

The present invention for adjusting the backlight and contrast of images displayed on display screen 101 is illustrated in FIG. 8. The process begins in step 801, and proceeds to step 802, where a software program running on microprocessor 201 will read the value residing within light meter register 207. As described above, this register value will have been inserted by light meter chip 206 as a result of a relative brightness level monitored by light meter 107. In step 803, the value read from light meter register 207 will be compared to light meter input values in the table illustrated in FIG. 6 to determine whether the backlight should be turned on or off and what level of contrast should be set for images to be displayed on display 101. The table illustrated in FIG. 6 is merely exemplary, but does suffice to illustrate that for each light meter input value that is read from light meter register 207, the table will output a value indicating whether the backlight switch should be on or off and what level of contrast should be inserted into contrast control register 204. As an example, if a light meter input value from light meter register 207 is a 0, indicating that the relative lighting within the environment the PDA is being utilized is low, then the desire within the preset settings in the table in FIG. 6 would be to turn on the backlight for the PDA screen 10 1, and to set the contrast level at 5. Thereafter, in step 804, the process will output the backlight switch and contrast values from the table of FIG. 6. In step 805, the backlight value read from the table will then be sent to backlighting switch register 204, and in step 806, the contrast value will be sent to contrast control register 204. The process ends in step 807.

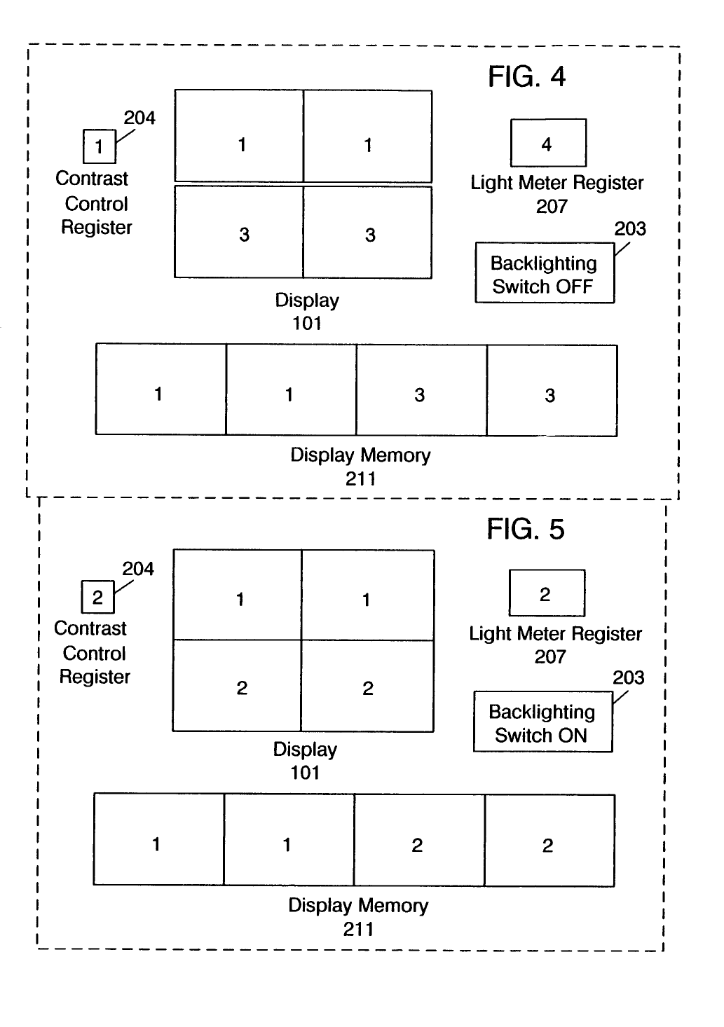

FIG. 4 illustrates an example of the operation of the process of FIG. 8. For this example, and for simplicity, it will be assumed that display 101 merely comprises four pixels, and thus display memory 211 will have four memory locations for storing the information needed to write images to these four pixels. Light meter register 207 will be read by step 802 as having a value of four. Step 803 will then compare this light meter register value of four with the backlight switch and contrast values and in step 804, the backlight switch value of OFF will be read and a contrast value of one will be read. In step 805, the backlight switch value of OFF will be sent to register 203, and the contrast value of one will be sent to contrast control register 204. The backlight switch register value of OFF will then be utilized by the backlight circuitry (not shown) within PDA 100 to turn off the backlight associated with display 101. Such a process is well known in the art. The contrast control register 204 value of one will then be utilized by the display driver 304 to adjust the contrast values in display 211, which will then cause these contrast values to determine the contrast associated with the four pixels 101. As noted previously, there are many existing display drivers and display related software programs capable of adjusting the contrast of the displayed pixels in response to external input, such as the input from contrast control register 204.

A second example of the process illustrated in FIG. 8 as shown in FIG. 5, where the light meter register 207 value is now read to be a 2, which results in the output of the backlight switch value being ON and the contrast value being a 2 when compared to the table in FIG. 6. The backlight switch ON value will be sent to register 203, and the contrast value of 2 will be sent to register 204, which will result in the contrast values in display memory 211 which are then used to vary the contrast of the four pixels in display 101 accordingly.

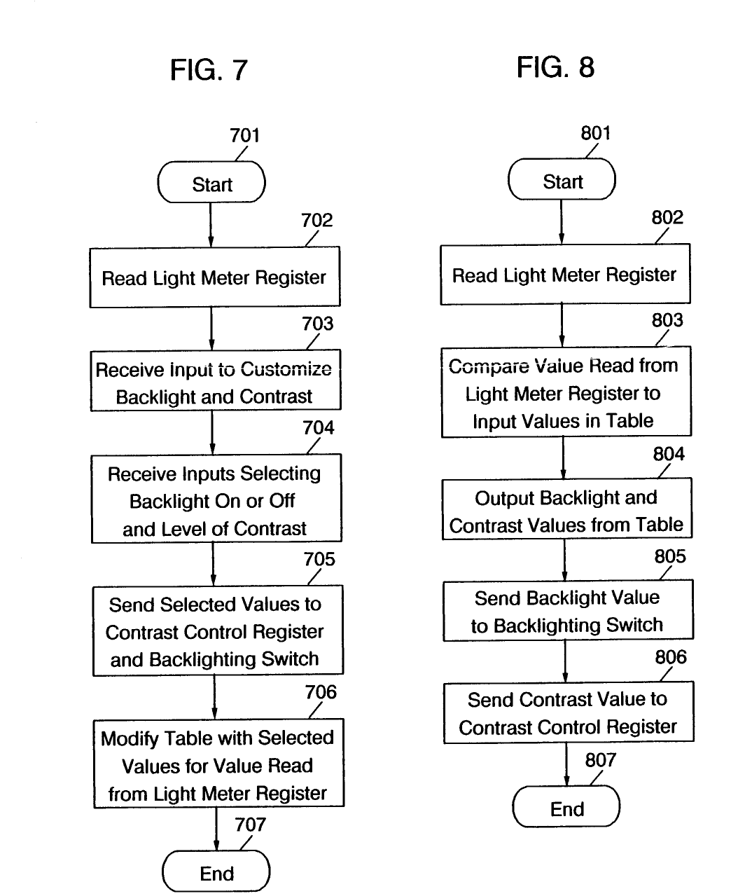

FIG. 7 illustrates a process for permitting a user of PDA 100 to customize the table in FIG. 6. The process begins with step 701, and proceeds to step 702 to read a value from light meter register 207. Essentially, the user of PDA 100 will customize the backlight switch and contrast values in the table in FIG. 6 as a function of the lighting environment in which the PDA 100 is currently being utilized. In step 703, input will be received from the user that the user wishes to customize the backlight and contrast values. This can be accomplished using many well known customization menus such as those available with windows based operating systems. In step 704, for the particular light meter register value the user can then input any changes the user desires for the backlight switch and contrast values pertaining to that light meter input value in the table in FIG. 6. In step 705, these selected values will then be sent to the contrast control register 204 and the backlighting switch 203, and these values will also be modified within the table in step 706. The process ends in step 707.

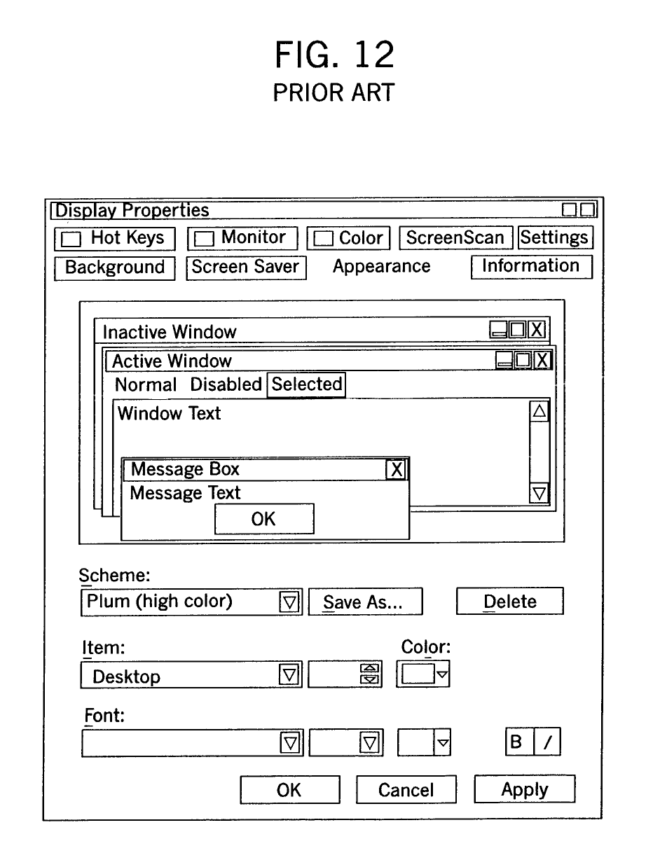

In an alternative embodiment of the present invention, the miniature color video camera 106 can be utilized to adjust the color settings for the display of information on display 101 as a function of the visible light conditions in which the PDA 100 is being used. FIG. 9 illustrates a table utilized by a process within PDA 100 in a manner similar to how the table of FIG. 6 is utilized. Essentially, the table in FIG. 9 has different color scheme settings for various visible light conditions. For example, if the miniature color video camera 106 determines that PDA 100 is being utilized within sunlight, then the color scheme setting A will be sent for the colors to be displayed on display 101. Likewise, if the physical light condition is determined to be flourescent light, then the color scheme setting B will be set. Likewise, if the physical light condition is determined to be incandescent light within which the PDA 100 is being utilized, then the color scheme setting will be set to C. The color scheme settings can take one of various different meanings. For example, each color scheme setting could have associated with it a text color, a background color, a menu color, etc. As each physical light condition changes, different color schemes associated with these various light conditions will then be utilized by the display chip 212 when it displays whatever application is being operated within PDA 100 on display 101. Such different color schemes are well known in the art as shown in FIG. 12, which shows how different color schemes can be set within a windows operating system.

Referring to FIG. 11, the process begins in step 1101, and proceeds to step 1102, where the lighting environmented is determined through the use of the miniature color video camera source 208. This can be determined in many different ways. For example, spots can be located in various areas of the lens of color video camera 106. Then as the outside lighting conditions change, the color values of those spots will also change, which will be monitored by video camera source 208. Source 208 will then set a value, such as a value between 0 and 255 for the color value of that spot. Since bright sunlight, flourescent light, and incandescent light all have different light spectrums, the color values of these spots on the lens of camera 106 will vary with these different lighting conditions. It would be quite simple for the manufacturer to therefore set the physical light conditions for various values monitored by video camera source 208 when receiving color values from these spots on the lens of video camera 106. The manufacturer can then set particular specified color schemes for each of these physical light conditions. In step 1103, the determined lighting environment will then be compared with the physical light condition inputs of the table in FIG. 9 to output a color scheme setting in step 1104. Step 1105 will then change the color settings of the application that is being displayed on display 101 in accordance with the color scheme setting being output. The process then ends in step 1106.

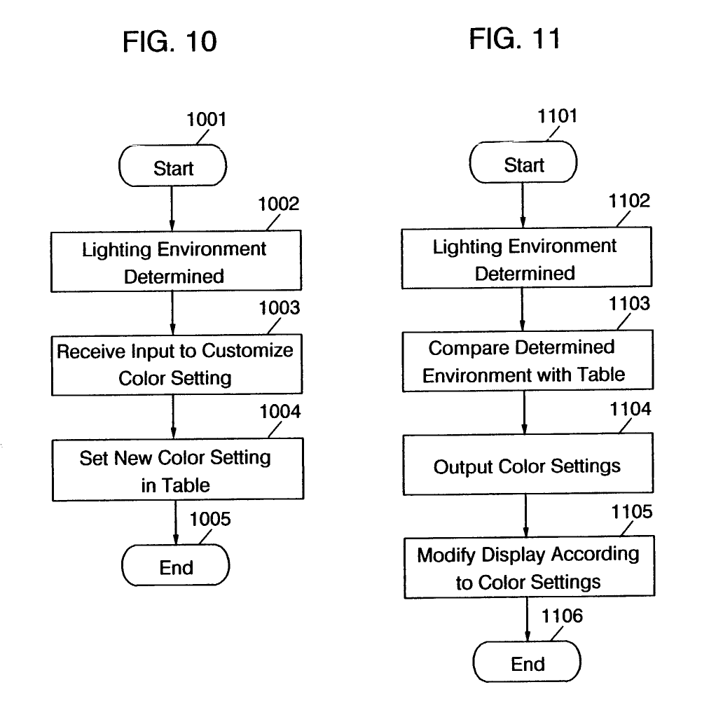

Naturally, the color scheme settings of FIG. 9 can be customized by the user in accordance with the process illustrated in FIG. 10. The process begins in step 1001, and in step 1002 the lighting environment within which the PDA 100 is currently being operated will be determined. In step 1003, the user will perform some type of action to begin the process for customizing the color settings in the table in FIG. 9. Again, FIG. 12 shows one embodiment for performing this kind of function. In step 1004, the new color setting can then be selected by the user and the process will end in step 1005.

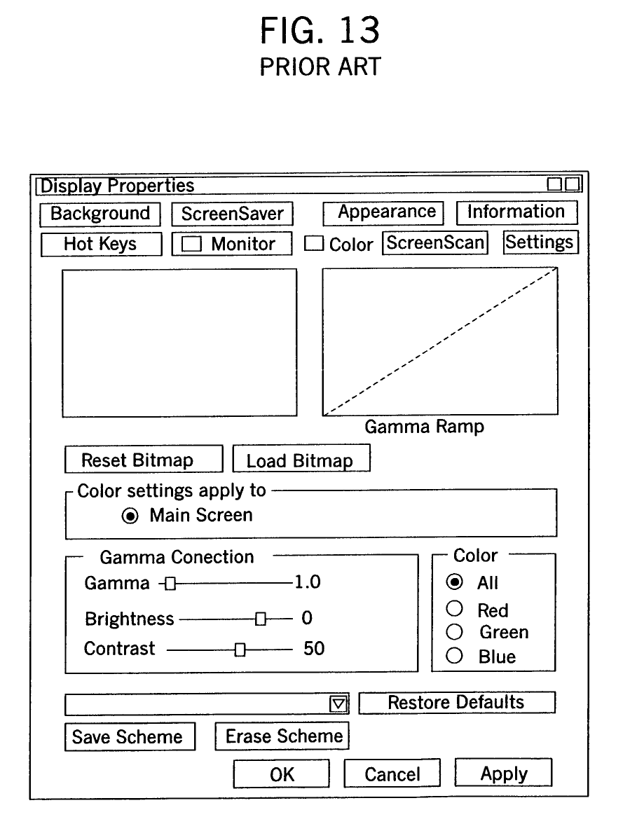

Not only color schemes can be selected, but also the various color values associated with these color schemes can also be customized. This process is also well known in the art as shown in FIG. 13, which shows a process that is used within Microsoft Windows to change color values.

The present invention is also advantageous for increasing software and hardware accessibility for persons with vision problems. For example, many persons find it difficult to distinguish small letters on a PDA without adequate contrast and/or backlighting. However, constant use of backlighting results in excessive battery consumption on such handheld devices. The present invention optimizes the viewability of images on the display screen for those with vision problems while reducing battery consumption for user readjustable settings. Moreover, persons with color blindness often have trouble viewing or distinguishing between images on a display screen under certain color schemes under certain types of light. The present invention can reduce this problem by enabling such users to customize the display screen to implement better viewable color schemes under such certain lighting conditions. Furthermore, many persons have motor disabilities or otherwise find it inconvenient to handle small knobs, etc. (such as the contrast knob). The present invention provides for increased accessibility for such PDAs by such individuals since they do not have to struggle with adjusting such control knobs.

Although the present invention and its advantages have been described in detail, it should be understood that various changes, substitutions and alterations can be made herein without departing from the spirit and scope of the invention as defined by the appended claims.

What is claimed is:

1. A data processing system comprising:
a display screen for displaying information;
an apparatus for monitoring relative lighting conditions of an environment within which the data processing system is operated; and
modifying a display characteristic of the display screen as a function of the relative lighting conditions monitored by the apparatus.

2. The system as recited in claim 1, wherein the apparatus is a light meter.

3. The system as recited in claim 2, wherein the display characteristic is a contrast level of the display screen.

4. The system as recited in claim 2, wherein the display characteristic is a backlight for illuminating the display screen.

5. The system as recited in claim 4, wherein the backlight is turned on or off as a function of the relative lighting conditions monitored by the light meter.

6. The system as recited in claim 1, wherein the apparatus is a video camera.

7. The system as recited in claim 6, wherein the display characteristic is a color scheme used to display the information on the display screen.

8. The system as recited in claim 2, wherein the display characteristic is a combination of a contrast level and a backlight illumination of the display screen.

9. The system as recited in claim 1, further comprising circuitry for adjusting the display characteristic for a particular monitored lighting condition in response to a user input.

10. A method for adjusting viewability of information on a data processing system display screen, comprising the steps of:
monitoring a relative lighting condition of an environment in which the data processing system is being operated; and
automatically adjusting a display characteristic of the display screen in response to the monitored relative lighting condition.

11. The method as recited in claim 10, wherein the display characteristic is a contrast level.

12. The method as recited in claim 10, wherein the display characteristic is a backlight illumination.

13. The method as recited in claim 11, wherein the monitoring step is performed by a light meter coupled to the data processing system.

14. The method as recited in claim 12, wherein the monitoring step is performed by a light meter coupled to the data processing system.

15. The method as recited in claim 10, wherein the display characteristic is a color scheme for displaying the information on the display screen.

16. The method as recited in claim 15, wherein the monitoring step is performed by a video camera coupled to the data processing system.

17. The method as recited in claim 10, wherein the adjusting step further comprises the steps of:
reading a value stored in a light meter register, wherein the value represents the relative lighting condition of the environment in which the data processing system is being operated as monitored by a light meter coupled to the light meter register;
using the value read from the light meter register to output a preprogrammed output value for the display characteristic of the display screen;
storing the output value for the display characteristic of the display screen in a display characteristic register; and
adjusting the display characteristic of the display screen as a function of the output value stored in the display characteristic register.

18. The method as recited in claim 17, wherein the display characteristic is a contrast level.

19. The method as recited in claim 17, wherein the display characteristic is a backlight on or off state.

20. The method as recited in claim 17, further comprising the step of receiving an input to customize the preprogrammed output value for the display characteristic of the display screen for a particular value read from the light meter register.

21. The method as recited in claim 20, wherein the input is received from a user of the data processing system.

22. A data processing system comprising:
a display screen;
circuitry for adjusting a contrast level for images displayed on the display screen;
a light meter;
a light meter register storing a value representing a relative illumination of lighting of an environment in which the data processing system resides as monitored by the light meter; and
circuitry for automatically signalling the adjusting circuitry to modify the contrast level as a function of the light meter register value.

23. The system as recited in claim 22, wherein the automatically signalling circuitry further comprises:
circuitry for reading the light meter register value;
circuitry for using the light meter register value read from the light meter register to determine a contrast level preprogrammed to correspond to the light meter register value; and
circuitry for storing the determined contrast level in a contrast control register coupled to the circuitry for adjusting the contrast level for images displayed on the display screen.

24. The system as recited in claim 22, further comprising:
a backlight for illuminating the display screen; and
circuitry for automatically switching the backlight on or off as a function of the light meter register value.

25. The system as recited in claim 24, wherein the automatically switching circuitry further comprises:
circuitry for using the light meter register value read from the light meter register to determine whether the backlight is preprogrammed to be on or off as a function of the light meter register value; and
circuitry for storing a value representing the determination whether the backlight is preprogrammed to be on or off in a backlight switch register coupled to the circuitry for automatically switching the backlight on or off.

26. A data processing system comprising:
a display screen;
a light meter;
a light meter register storing a value representing a relative illumination of lighting of an environment in which the data processing system resides as monitored by the light meter;
a backlight for illuminating the display screen; and
circuitry for automatically switching the backlight on or off as a function of the light meter register value.

27. The system as recited in claim 26, wherein the automatically switching circuitry further comprises:
circuitry for using the light meter register value read from the light meter register to determine whether the backlight is preprogrammed to be on or off as a function of the light meter register value; and
circuitry for storing a value representing the determination whether the backlight is preprogrammed to be on or off in a backlight switch register coupled to the circuitry for automatically switching the backlight on or off.

28. The system as recited in claim 26, further comprising:
circuitry for adjusting a contrast level for images displayed on the display screen; and
circuitry for automatically signalling the adjusting circuitry to modify the contrast level as a function of the light meter register value.

29. The system as recited in claim 28, wherein the automatically signalling circuitry further comprises:
circuitry for reading the light meter register value;
circuitry for using the light meter register value read from the light meter register to determine a contrast level preprogrammed to correspond to the light meter register value; and
circuitry for storing the determined contrast level in a contrast control register coupled to the circuitry for adjusting the contrast level for images displayed on the display screen.
